(19) United States
(12) Patent Application Publication
(10) Pub. No.: US 2010/0302771 A1
(43) Pub. Date: Dec. 2, 2010

(54) LED-based streetlamp for emitting white light with easily adjustable color temperature

(75) Inventors: Joe Yang, Taichung City (TW); Kai-Ren Yang, Taichung City (TW)

Correspondence Address: CHARLES E. BAXLEY, ESQUIRE, 90 JOHN STREET, SUITE 309, NEW YORK, NY, 10038, US

(73) Assignee: Joe Yang

(21) Appl. No.: 12/455,499

(22) Filed: Jun. 2, 2009

(51) Int. Cl. F21V 9/00

(52) U.S. Cl. 362/231

(57) ABSTRACT

Disclosed is an LED-based streetlamp for emitting white light with easily adjustable color temperature. The LED-based streetlamp includes at least one substrate, at least three red LED packages, at least three green LED packages, at least three blue LED packages and a lamp holder. The red, green and blue LED packages are provided on the substrate. Each of the LED packages includes scattering particles for providing preferred senses of direction of light so that red, green and blue light beams cast from the red, green and blue LED packages almost completely overlap to provide a white light beam.

### BACKGROUND OF INVENTION

1. Field of Invention

The present invention relates to a street light and, more particularly, to an LED-based street light for emitting white light with easily adjustable color temperature.

2. Related Prior Art

A light-emitting diode (“LED”) is low in consumption of energy and high in efficiency of illumination. Therefore, a lot of efforts have been cast on LEDs for illumination.

Referring to FIG. 1, a conventional LED-based lighting module includes a red LED 1, a green LED 2 and a blue LED 3 connected to a circuit board 4. The circuit board 4 is connected to a terminal for connection to the mains or a socket of a lighting module. Red light, green light and blue light are mixed into white light. Wavelengths and intensities must be selected carefully. Therefore, the mixture is difficult, and white light only exists in a central zone where red, green and blue light beams overlap. The light turns to red, green and blue in areas away from the central zone. That is, there are color blocks.

Referring to FIG. 2, another conventional LED-based lighting module includes a red LED 1, a green LED 2 and a blue LED 3 connected to a circuit board 4. The circuit board 4 is connected to a terminal for connection to the mains or a socket of a lighting module. A lens 5 is located in front of the circuit board 4. The lens 5 is added with fluorescent powder 6 for mixing red light, green light and blue light into white light. However, the angle of the white light is limited. Moreover, the LEDs 1, 2 and 3 generate a lot of heat as a byproduct while emitting light. The fluorescent powder 6 is however vulnerable to heat and deteriorates with rising temperature so that there is serious optical decay.

The wavelength of light emitted from an LED is determined by the structure of the epitaxy, materials used therein and the matching of lattices. The wavelength of the light emitted from the LED suffers thermal drift. That is, at the moment when the multi-chip LED lighting is actuated, the intensity of the red light is high so that the white light tends to be a warm color. As the multi-chip LED lighting goes on, the intensity of the blue light gets higher so that the white light tends to be a cold color. The thermal drift of the white light might be too big to achieve a good white balance. The intensity of illumination would be compromised accordingly.

The present invention is therefore intended to obviate or at least alleviate the problems encountered in prior art.

### SUMMARY OF INVENTION

It is the primary objective of the present invention to provide an LED-based streetlamp for emitting white light with easily adjustable color temperature.

To achieve the foregoing objective, the streetlamp includes at least one substrate, at least three red light-emitting diode packages, at least three green light-emitting diode packages, at least three blue light-emitting diode packages and a transparent tube for containing the substrate. The light-emitting diode packages are provided on the substrate. Each of the light-emitting diode packages includes a light-emitting diode chip, a lens for wrapping the light-emitting diode chip and scattering particles spread in the lens.

Other objectives, advantages and features of the present invention will become apparent from the following description referring to the attached drawings.

### BRIEF DESCRIPTION OF DRAWINGS

The present invention will be described via detailed illustration of embodiments versus prior art referring to the drawings.

FIG. 1 is a cross-sectional view of a conventional LED-based lighting module.

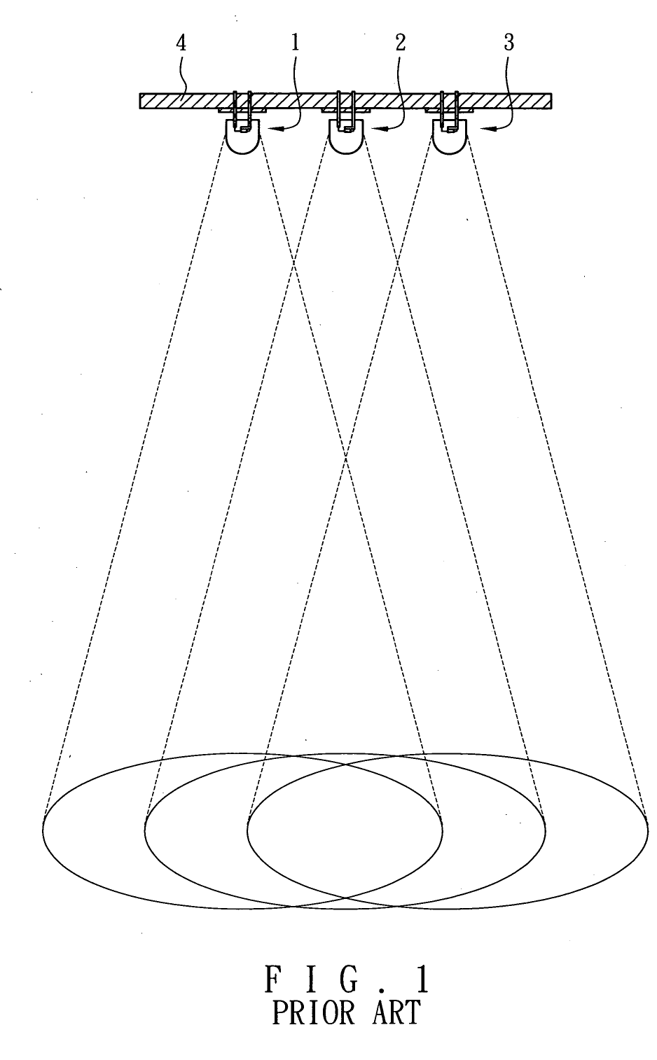

FIG. 2 is a cross-sectional view of another conventional LED-based lighting module.

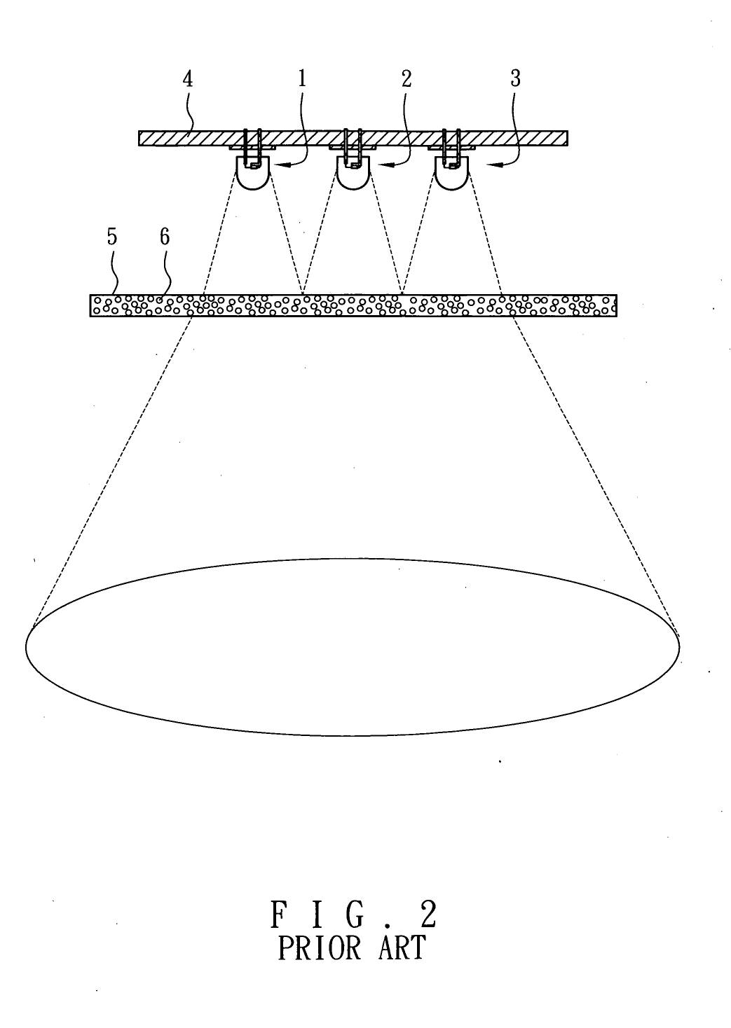

FIG. 3 is an exploded view of an LED-based streetlamp according to a first embodiment of the present invention.

FIG. 4 is an enlarged cross-sectional view of the LED-based streetlamp shown in FIG. 3.

FIG. 5 is a partial cross-sectional view of the LED-based streetlamp shown in FIG. 3.

FIG. 6 is a cross-sectional view of an LED-based streetlamp according to a second embodiment of the present invention.

FIG. 7 is a cross-sectional view of an LED-based streetlamp according to a third embodiment of the present invention.

FIG. 8 is a cross-sectional view of an LED-based streetlamp according to a fourth embodiment of the present invention.

### DETAILED DESCRIPTION OF EMBODIMENTS

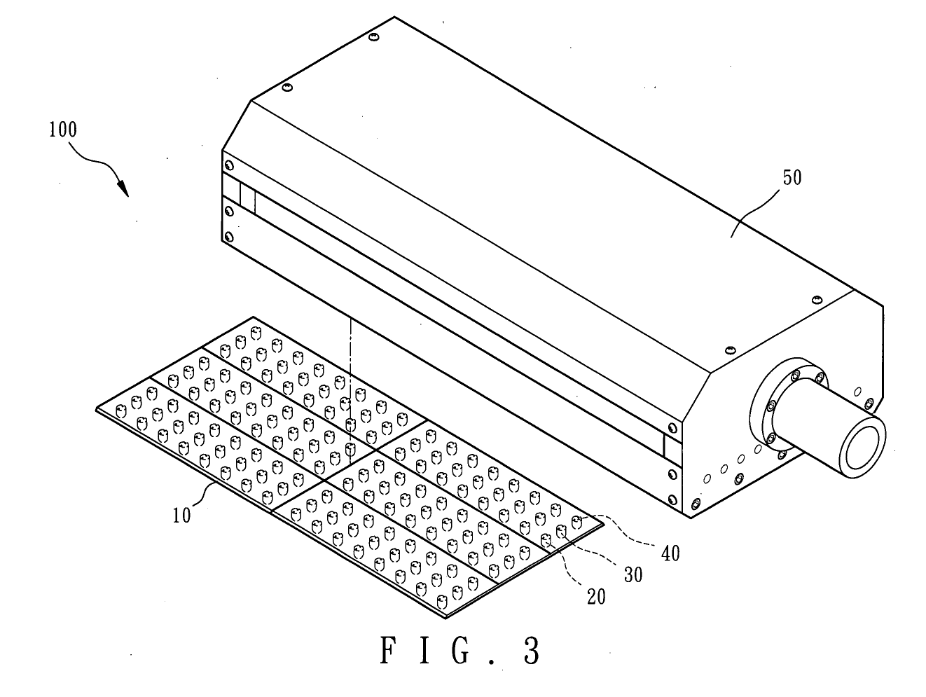

Referring to FIGS. 3 through 5, an LED-based streetlamp 100 includes substrates 10, red LED packages 20, green LED packages 30, blue LED packages 40 and a lamp holder 50 according to a first embodiment of the present invention. Each of the substrates 10 is a printed circuit board with predetermined wiring. The substrates 10 are electrically connected to one another. In another embodiment, the substrates 10 can however be isolating plates, and the LED packages 20, 30 and 40 are connected to one another with jumpers.

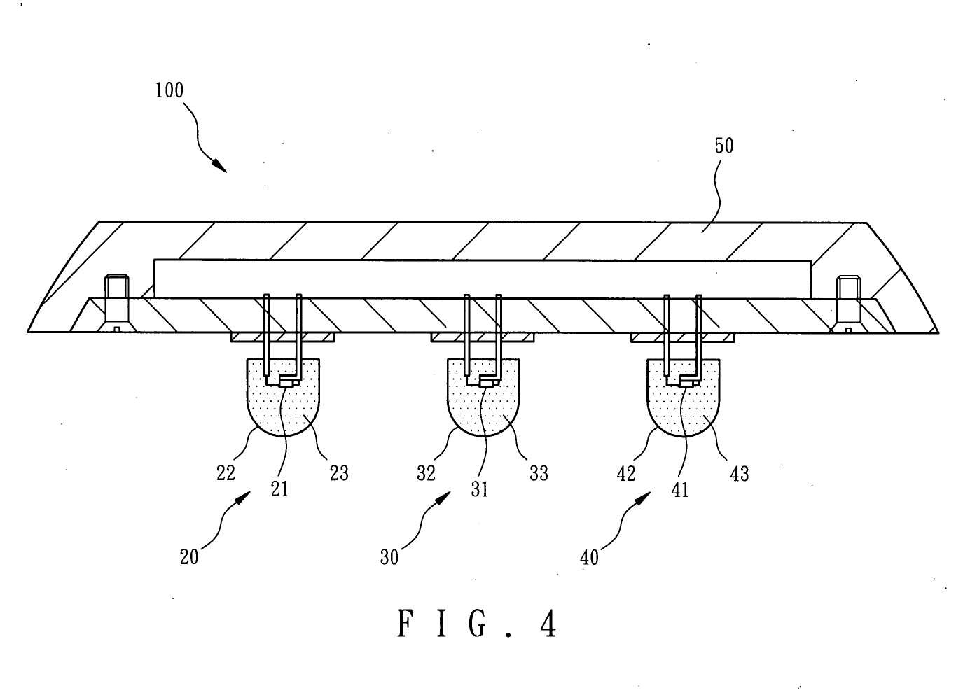

Referring to FIG. 4, each of the red LED packages 20 includes a red LED chip 21, a lens 22 and scattering particles 23. Given a certain current, the red LED chip 21 emits red light. The lens 22 is made of a transparent material such as epoxy, silicone and glass. The lens 22 is used to wrap the LED chip 21. The scattering particles 23 are scattered in the lens 22. The red LED packages 20 are located in predetermined positions on the substrates 10. The red LED packages 20 are electrically connected to the substrates 10 so that the former are actuated to emit red light with electricity from the latter.

Similarly, each of the green LED packages 30 includes a green LED chip 31, a lens 32 and scattering particles 33. The GL LED packages 30 are located in predetermined positions on the substrates 10.

Similarly, each of the blue LED packages 40 includes a blue LED chip 41, a lens 42 and scattering particles 43. The BL LED packages 40 are located in predetermined positions on the substrates 10.

The scattering particles 23, 33, and 43 are made of at least one highly reflective or scattering material. For example, they can be made of silver, calcium carbonate (CaCO₃) and/or silicon dioxide (SiO₂), alone or in combination with resin.

The lamp holder 50 is made of an opaque material. The lamp holder 50 is used to support the substrates 10. The substrates 10 are provided on a side of the lamp holder 50. The lamp holder 50 can be attached to a lamp post.

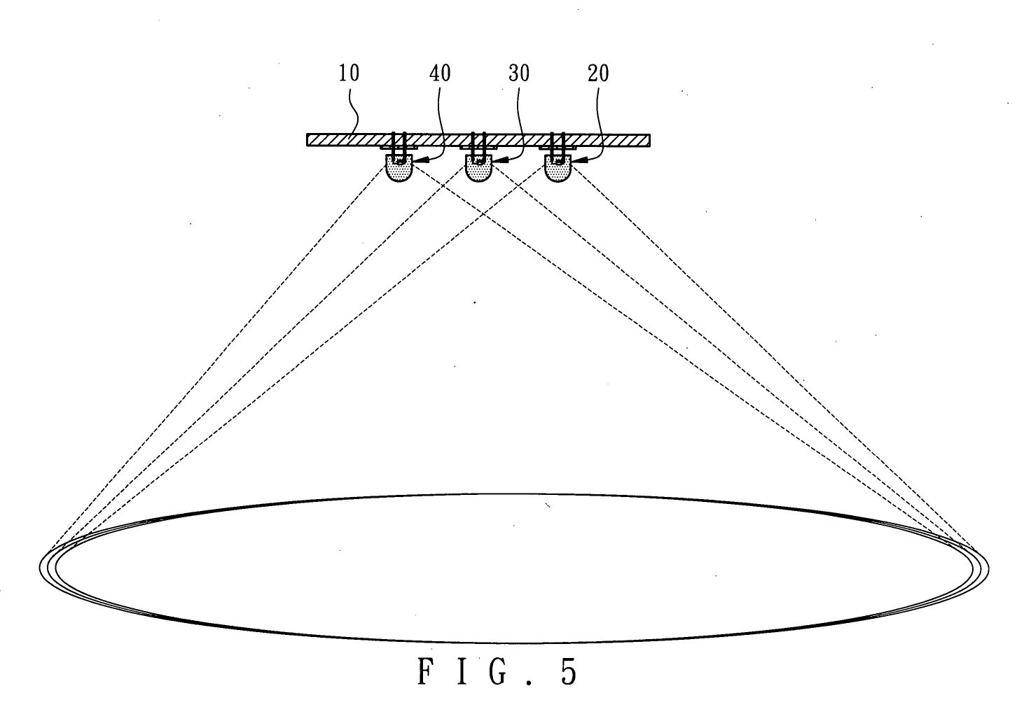

Referring to FIG. 5, the red LED packages 20 cast red light beams. The green LED packages 30 cast green light beams. The blue LED packages 40 cast blue light beams. The numbers and positions of the scattering particles 23, 33 and 43 disposed in the lens of each of the LED packages 20, 30 and 40 are carefully determined so that the scattering particles 23, 33 and 43 cause the LED packages 20, 30 and 40 to cast light beams that almost completely overlap one another, leaving small color blocks. The color blocks are too small to be observed by humans. That is, the red light, the green light and the blue light are well mixed into white light. The numbers and positions of the scattering particles 23, 33 and 43 respectively used in the LED packages 20, 30 and 40 are different from one another.

Moreover, the LED chips 21, 31 and 41 are packaged independent of one another. Hence, the heat radiation of the streetlamp 100 is better than that of a conventional streetlamp with LED chips packaged in a common lens.

Furthermore, since there are several red LED packages 20, several green LED packages 30 and several blue LED packages 40 on the substrates 10, they can be replaced with one another or their positions can be changed to adjust the color temperature from cold to warm. For example, the color temperature of light for suburbs can be different from the color temperature of light for urban areas. In the suburbs where vehicles are driven at high speed, the color temperature of the light can be high. In the urban areas where vehicles are driven at low speed, the color temperature of the light can be low. The color temperature of the light emitted from the streetlamp 100 can easily be adjusted without having to use a complicated mechanism to change currents or voltages provided to the LED packages.

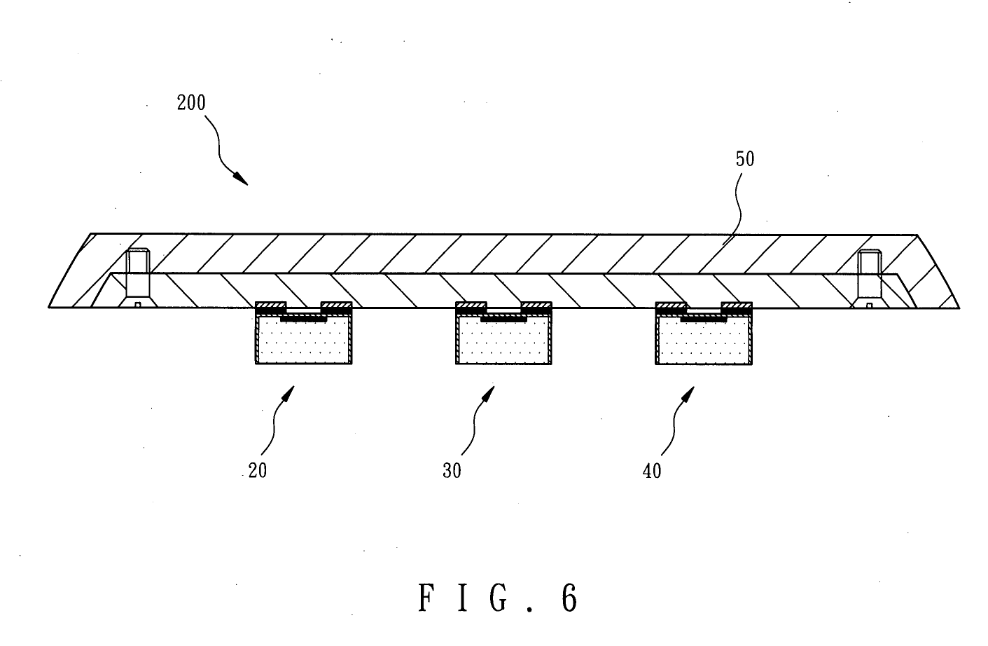

Referring to FIG. 6, there is shown a streetlamp 200 according to a second embodiment of the present invention. The streetlamp 200 is like the streetlamp 100 except including LED packages 20′, 30′ and 40′ instead of the LED packages 20, 30 and 40, respectively. The LED packages 20′, 30′ and 40′ are of a surface mount device type while the LED packages 20, 30 and 40 are of an LED lamp type. That is, the LED packages 20′, 30′ and 40′ are attached to the substrates 10 different than the LED packages 20, 30 and 40 are attached to the substrate 10. In another embodiment, the LED packages can be of a flip chip type.

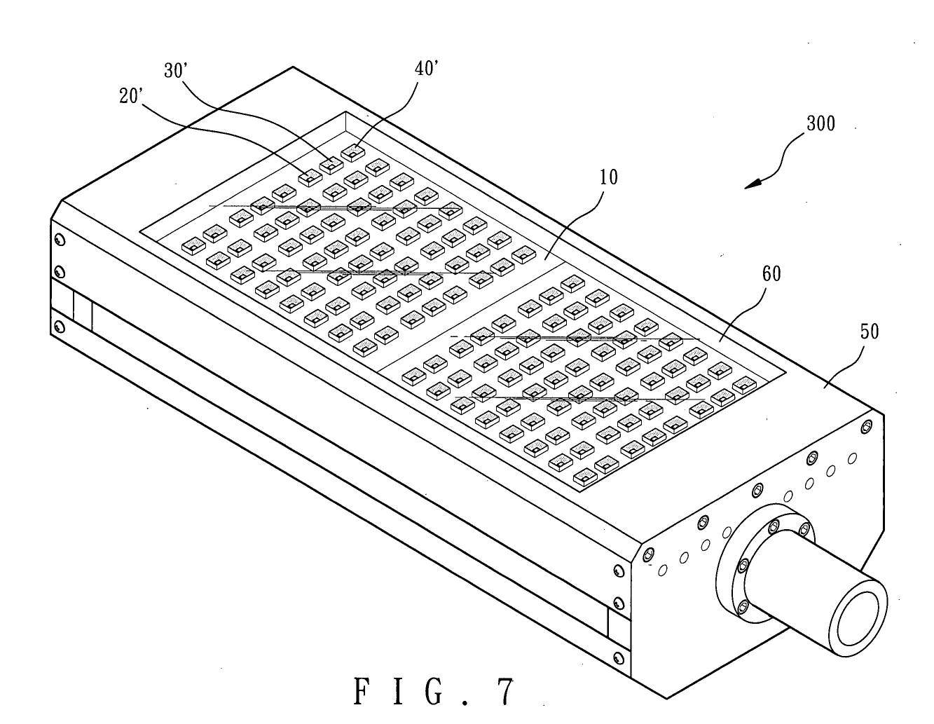

Referring to FIG. 7, there is shown a streetlamp 300 according to a third embodiment of the present invention. The streetlamp 300 is like the streetlamp 200 except including a light-enhancing panel 60. The light-enhancing panel 60 is made of a transparent material such as epoxy, silicon and glass. The light-enhancing panel 60 is attached to the lamp holder 50 so that light emitted from the LED packages 20, 30 and 40 travels through the light-enhancing panel 60 and travels further than without the light-enhancing panel 60.

In another embodiment, the light-enhancing panel 60 can be replaced with a scattering panel including a transparent panel and scattering particles scattered in the transparent panel. Such a transparent panel is made of a transparent material such as epoxy, silicone and glass. Such scattering particles are made of at least one highly reflective or scattering material, alone or in combination with resin. Such a highly reflective or scattering material can be as silver, calcium carbonate and silicon dioxide for example. Thus, the color blocks as mentioned referring to FIGS. 3 through 5 can be eliminated completely.

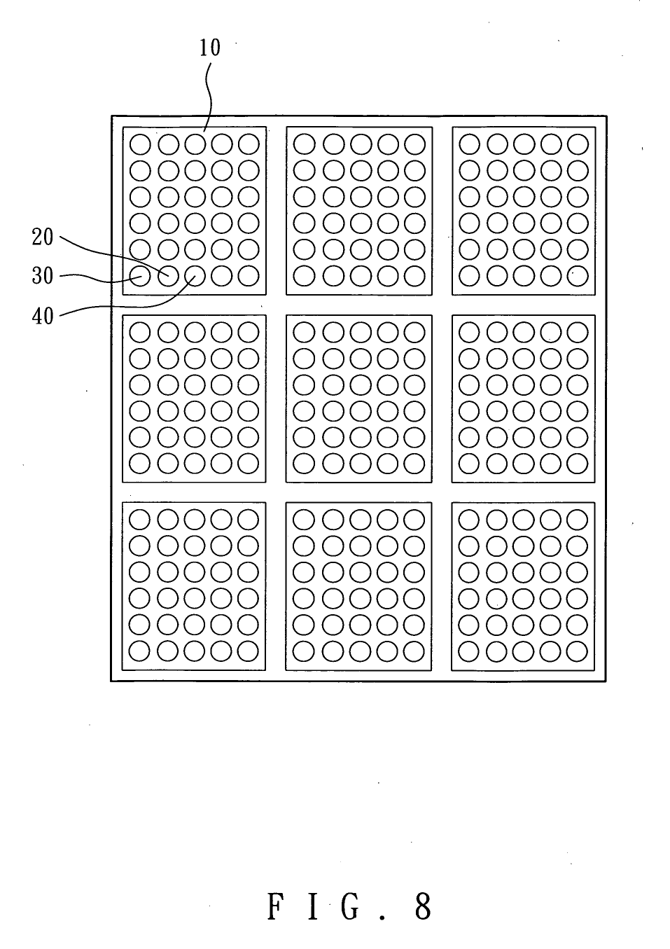

With referring to FIG. 8, there is shown an LED-based streetlamp in accordance with a fourth embodiment. The fourth embodiment is like the first embodiment except including different numbers of LED packages 20, 30 and 40 in different positions.

Furthermore, there can be provided additional LED packages like the LED packages 20, 30 and 40 except emitting light of a fourth color. The wavelength of the light of the fourth color can be 560 nm to 610 nm. Light with a wavelength of 560 nm to 610 nm is yellow light. Yellow light is mixture of red light with green light. Yellow light can be mixed with blue light into white light.

Alternatively, the wavelength of the light of the fourth color can be wavelength of 470 nm to 500 nm. Light with a wavelength of 470 nm to 500 nm is bluish green light. Such LED packages for emitting such light of such a fourth color can be of the surface-mount-device type or the LED-lamp type.

The numbers of the LED packages can be reduced by increasing the power of the LED packages to 1 watt for example.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A streetlamp comprising:
at least one substrate;
at least three red light-emitting diode packages, at least three green light-emitting diode packages and at least three blue light-emitting diode packages provided on the substrate and each formed with a light-emitting diode chip electrically connected to the substrate, a lens for wrapping the light-emitting diode chip and scattering particles spread in the lens; and
a lamp holder for supporting the substrate.

2. The streetlamp according to claim 1 comprising:
a collar comprising a first section for receiving an end of the transparent tube and a second section; and
a cap for receiving the second section of the collar; and
two pins extended through the cap and each formed with an end electrically connected to the substrate.

3. The streetlamp according to claim 1, wherein the lenses are made of a material selected from a group consisting of epoxy, silicone and glass.

4. The streetlamp according to claim 1, wherein the scattering particles are made of a material selected from a group consisting of a highly reflective material and a highly scattering material.

5. The streetlamp according to claim 1, wherein the scattering particles are made of at least one material selected from a group consisting of silver, calcium carbonate, silicon dioxide and resin.

6. The streetlamp according to claim 1 comprising a light-enhancing panel made of a transparent material and attached to the lamp holder so that light emitted from the light-emitting diode packages travels through the light-enhancing panel.

7. The streetlamp according to claim 1 comprising a scattering panel attached to the lamp holder so that light emitted from the light-emitting diode packages travels through the scattering panel.

8. The streetlamp according to claim 7, wherein the scattering panel is made of a material selected from a group consisting of a highly reflective material and a highly scattering material.

9. The streetlamp according to claim 7, wherein the scattering panel is made of at least one material selected from a group consisting of silver, calcium carbonate, silicon dioxide and resin.

10. The streetlamp according to claim 1, wherein the light-emitting diode packages are of a light-emitting diode lamp type.

11. The streetlamp according to claim 1, wherein the light-emitting diode packages are of a surface mount device type.

12. The streetlamp according to claim 1, wherein the light-emitting diode packages are of a flip chip type.

13. The streetlamp according to claim 1 comprising fourth-color light-emitting diode packages.
